(19) United States
(12) Patent Application Publication
(10) Pub. No.: US 2019/0102463 A1
(43) Pub. Date: Apr. 4, 2019

(54) SYSTEMS AND METHODS FOR PROVIDING LOCATION-BASED SUBSCRIPTIONS AND NOTIFICATIONS

(71) Applicant: Facebook, Inc., Menlo Park, CA (US)

(72) Inventor: Yunzhi Ye, Seattle, WA (US)

(21) Appl. No.: 15/720,506

(22) Filed: Sep. 29, 2017

(51) Int. Cl. G06F 17/30; G06Q 30/02; G06Q 50/00; G06N 99/00

(52) U.S. Cl. CPC G06F 17/30867; G06F 17/3087; G06N 99/005; G06Q 30/0261; G06Q 50/01; G06Q 30/0257

(57) ABSTRACT

Systems, methods, and non-transitory computer-readable media can receive a request from a user associated with a particular location to receive location-based notifications for the particular location. A subscription associated with the user and the particular location is generated. One or more pages associated with the particular location are identified. A location-based notification comprising the one or more pages is generated for the user.

### FIELD OF THE INVENTION

The present technology relates to the field of social networking systems. More particularly, the present technology relates to systems and methods for generating and providing location-based subscriptions and notifications.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system can include pages that are associated with users or entities. The pages can be dedicated locations on the social networking system to reflect the presence of the users and entities on the social networking system. The users and entities associated with such pages can be provided with the opportunity to interact with other users on the social networking system.

### SUMMARY

Various embodiments of the present disclosure can include systems, methods, and non-transitory computer readable media configured to receive a request from a user associated with a particular location to receive location-based notifications for the particular location. A subscription associated with the user and the particular location is generated. One or more pages associated with the particular location are identified. A location-based notification comprising the one or more pages is generated for the user.

In an embodiment, a set of new pages is identified. Each new page in the set of new pages is a page that has been created within a threshold period of time. The identifying one or more pages comprises selecting the one or more pages from the set of new pages.

In an embodiment, a set of candidate pages is generated by selecting a subset of the set of new pages based on candidate page criteria. The one or more pages are selected from the set of candidate pages.

In an embodiment, the set of candidate pages are ranked based on ranking criteria, and the one or more pages are selected from the set of candidate pages based on the ranking.

In an embodiment, the ranking criteria are implemented based on a machine learning model.

In an embodiment, the candidate page criteria comprise embedding similarity score criteria.

In an embodiment, the candidate page criteria comprise page interaction criteria.

In an embodiment, location-based notifications are periodically generated for the user based on the subscription, and each location-based notification comprises one or more pages associated with the particular location.

In an embodiment, location-based notifications are periodically generated for the user based on the subscription, and each location-based notification comprises one or more new pages that have been created within a threshold period of time and are associated with the particular location.

In an embodiment, the subscription is associated with a particular page category, and the identifying the one or more pages associated with the particular location comprises identifying one or more pages associated with the particular location and the particular page category

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a location-based notifications module, according to an embodiment of the present disclosure.

FIG. 2 illustrates an example notification generation module, according to various embodiments of the present disclosure.

FIG. 3 illustrates an example scenario associated with receiving a user request to subscribe to location-based notifications, according to various embodiments of the present disclosure.

FIG. 4 illustrates an example scenario associated with providing a location-based notification, according to an embodiment of the present disclosure.

FIG. 5 illustrates an example method associated with generating location-based notifications, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Location-Based Subscriptions and Notifications

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. The pages can be dedicated locations on the social networking system to reflect the presence of the entities on the social networking system. A page can publish content that is deemed relevant to its associated entity to promote engagement with the page. Pages on the social networking system may provide users of the social networking system with an opportunity to discover and interact with the various entities associated with the pages.

Under conventional approaches, a page associated with an entity may be managed by one or more users associated with the page. Such users may sometimes be referred to as administrators or “admins.” When a user wishes to create a page, the user may be asked to provide certain page information. Page information can include, for example, a name for the page, a description of the page, a profile image for the page, and/or a category for the page. In a large social networking system, many pages may be created by users every day. Due to the large number of pages being created, it may be an overwhelming task for other users of the social networking system to try to discover new pages that may be interesting or relevant to them. Furthermore, given the large number of pages that may already be in existence and the large number of pages being created, many newly created pages may fail to attract the attention of other users on the social networking system. As such, a page may not receive significant interaction from other users in the weeks or months after the page has been created. As a result, such pages may become inactive due to a lack of interest or interaction from other users.

An improved approach rooted in computer technology overcomes the foregoing and other disadvantages associated with conventional approaches specifically arising in the realm of computer technology. In general, a user can be provided with the ability to subscribe to location-based notifications. In various embodiments, a user can be associated with a particular location. By subscribing to location-based notifications, a user can be provided with notifications of pages that are also associated with the particular location. In certain embodiments, a user can be provided with notifications of new pages that have been recently created and are associated with the particular location. For example, if a user lives in San Jose, Calif., the user can subscribe to location-based notifications for San Jose. Based on the user's subscription, the user can receive notifications of new pages that are created on a social networking system that are associated with San Jose, Calif., such as pages for new restaurants, cafes, markets, schools, events, etc. in San Jose.

In various embodiments, a set of new pages can be identified. The set of new pages can include, for example, pages on a social networking system that have been created within a threshold number of days. A subset of the set of new pages can be selected based on candidate page criteria to generate a set of candidate pages. The candidate page criteria can include, for example, location criteria, user affinity criteria, page interaction criteria, and the like. The set of candidate pages can be ranked based on ranking criteria. In certain embodiments, the ranking criteria can be implemented based on a machine learning model that is trained to rank pages based on a likelihood that a particular user will interact with a page if the page is presented to the user. One or more pages can be selected from the set of candidate pages based on the ranking. The one or more pages can be provided to a user in a location-based notification. In certain embodiments, a user may receive periodic, regular, and/or intermittent location-based notifications (e.g., daily, weekly, etc.) based on the user's subscription to location-based notifications. The present disclosure, including these concepts and others, is described in greater detail herein.

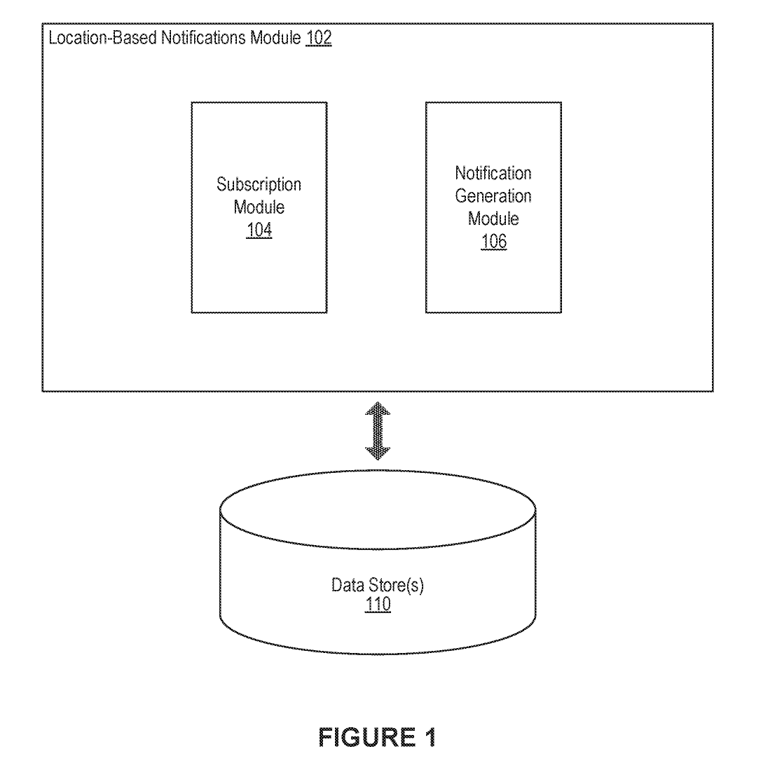

FIG. 1 illustrates an example system 100 including an example location-based notifications module 102, according to an embodiment of the present disclosure. The location-based notifications module 102 can be configured to generate and provide location-based notifications to a user based on a location (or multiple locations) associated with the user, i.e., a user location. In various embodiments, a location-based notification can inform a user of new pages that have been created on a social networking system that are associated with the user's user location. In one embodiment, the location-based notifications module 102 can be configured to receive a request from a user to receive location-based notifications. The location-based notification module 102 can generate a subscription for the user to receive location-based notifications for the user's user location. Based on the user's subscription to location-based notifications, the location-based notifications module 102 can generate a set of pages. The set of pages can, in various embodiments, comprise a set of new pages that have been created on a social networking system within a threshold period of time (e.g., within the past week, the past month, etc.). The location-based notifications module 102 can select a subset of the set of new pages to generate a set of candidate pages based on candidate page criteria. The set of candidate pages can be ranked based on ranking criteria. The ranking criteria can, in various embodiments, be implemented based on a machine learning model. For example, the machine learning model can be trained to rank a set of pages based on a likelihood that a particular user will interact with a page if the page is presented to the user. The location-based notifications module 102 can select one or more pages from the set of candidate pages based on the ranking. The location-based notifications module 102 can generate a location-based notification which identifies the one or more pages. The location-based notifications module 102 can provide the location-based notification to a user. In various embodiments, the location-based notifications module 102 can be configured to periodically generate location-based notifications and provide them to the user while the user is subscribed to receive location-based notifications. For example, location-based notifications can be generated and provided to the user daily or weekly. While some illustrations discussed herein relate to a single user location associated with a user for ease of illustration, the present disclosure applies equally to multiple user locations associated with a user.

As shown in the example of FIG. 1, the location-based notifications module 102 can include a subscription module 104 and a notification generation module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the location-based notifications module 102 can be implemented in any suitable combinations.

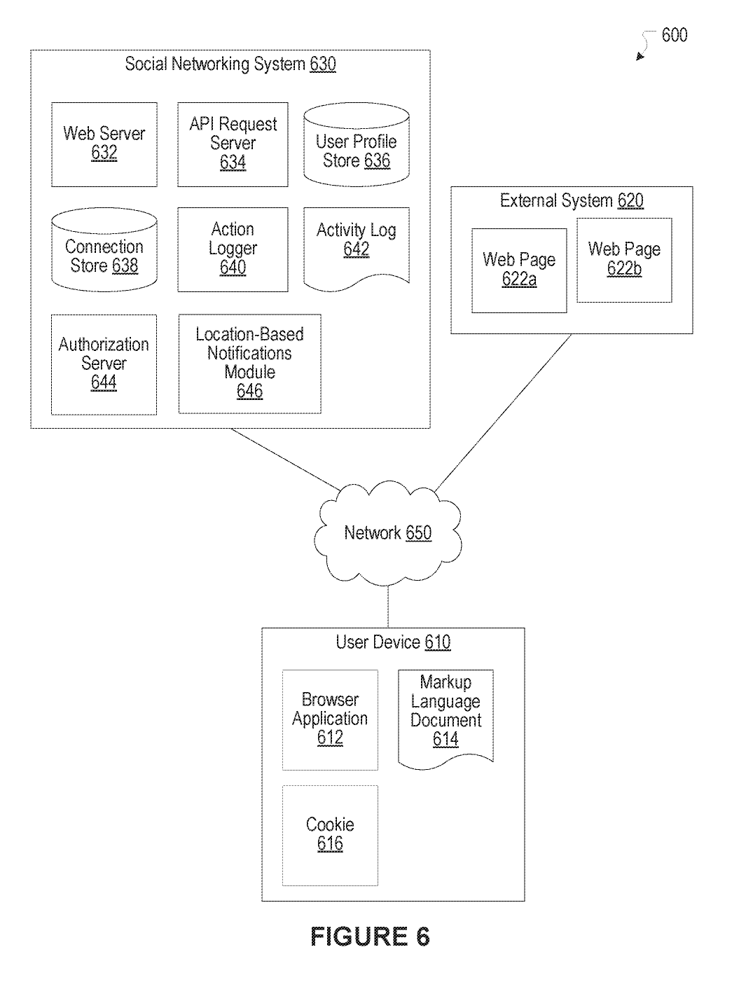

In some embodiments, the location-based notifications module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the location-based notifications module 102 can be implemented, in part or in whole, as software running on one or more computing devices or systems, such as on a user or client computing device. For example, location-based notifications module 102, or at least a portion thereof, can be implemented as or within an application (e.g., app), a program, or an applet, etc., running on a user computing device or a client computing system, such as the user device 610 of FIG. 6. In another example, the location-based notifications module 102, or at least a portion thereof, can be implemented using one or more computing devices or systems that include one or more servers, such as network servers or cloud servers. In some instances, the location-based notifications module 102 can, in part or in whole, be implemented within or configured to operate in conjunction with a social networking system (or service), such as the social networking system 630 of FIG. 6. It should be understood that there can be many variations or other possibilities.

The location-based notifications module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the location-based notifications module 102. For example, the data store 110 can store user location information, page location information, candidate page criteria, page ranking criteria, user embedding information, page embedding information, and the like. It is contemplated that there can be many variations or other possibilities.

The subscription module 104 can be configured to receive and process a user request to subscribe to location-based notifications. In certain embodiments, a user can be presented with a selectable interface object that allows the user to subscribe to location-based notifications. For example, the selectable interface object may be a link or a button that is presented via a social networking system user interface. In this example, if a user interacts with a content post posted by a page that appears in a news feed, the user may be presented with an option to subscribe to location-based notifications. A user interaction may include, for example, liking, commenting on, and/or sharing the content post. In another example, if a user visits a page on a social networking system, the user can be provided with a link or a button on the page that allows the user to subscribe to location-based notifications. In certain embodiments, a user may be provided with the option to subscribe to location-based notifications if the user is visiting a page that is associated with the user's user location. For example, if a user is visiting a page for a local coffee shop in the user's city of residence, the user can be presented with the option to subscribe to location-based notifications, but if the user is visiting a page associated with a nationwide coffee shop chain, then the user may not be presented with the option to subscribe to location-based notifications. In yet another example, the user can be provided with a selectable interface object to subscribe to location-based notifications if the user has performed a search for pages, and the search specifies location criteria. For example, if a user enters a search for pizza restaurants in Seattle, Wash., the user may be provided with the option to subscribe to location-based notifications for Seattle, Wash.

As discussed above, a user can be associated with a particular location, i.e., a user location. A user's subscription to location-based notifications may also be associated with the user's user location such that the user receives location-based notifications that are specific to the user's user location. For example, a user that resides in Seattle, Wash. may be interested in being informed of new pages associated with Seattle (e.g., associated with entities located in Seattle), but likely would not be interested in receiving notifications of new pages associated with Los Angeles. In another example, a user may be interested in being informed of new pages associated with a location even if the user does not live in the location if, for example, the user works in the location, frequently visits the location, or otherwise spends a significant amount of time in the location. The subscription module 104 can be configured to determine a user location for a user, such that the user is associated with the user location. A user's user location may be, for example, a predicted location of residence for the user, or a predicted location in which the user spends the most time. For example, a user's associated user location can be predicted and/or determined based on locations in which the user has checked in on a social networking system, locations in which the user has been tagged by other users on the social networking system, and/or a current city of residence identified by the user. When a user subscribes to receive location-based notifications, the subscription module 104 can generate a subscription that is associated with the user and is also associated with a user location associated with the user. In various embodiments, locations associated with a page and/or a user can be defined to varying levels of granularity, as appropriate. For example, certain user and/or page locations may be cities, while in other instances, user and/or page locations may be a ZIP code or a neighborhood within a city. The latter scenario may be the case, for example, if a particular city is very large, and it is determined that it would be more practical to identify a user's location and/or a page's location based on neighborhood or ZIP code.

In certain embodiments, a subscription can also be associated with a particular page category. For example, a user may be interested in receiving notifications of new restaurants in the user's immediate geographic area, but may not be interested in receiving notifications of other types of new stores, such as new bookstores or new flower shops. As such, a user can be provided with the option to subscribe to location-based notifications associated with the user's user location and also associated with a particular page category.

Users can also be provided with the option to cancel a subscription or opt-out of location-based notifications. In various embodiments, a user can be periodically provided with location-based notifications as long as the user has an active subscription to location-based notifications. For example, while a user has an active subscription, the user can be provided with location-based subscriptions once a day or once a week.

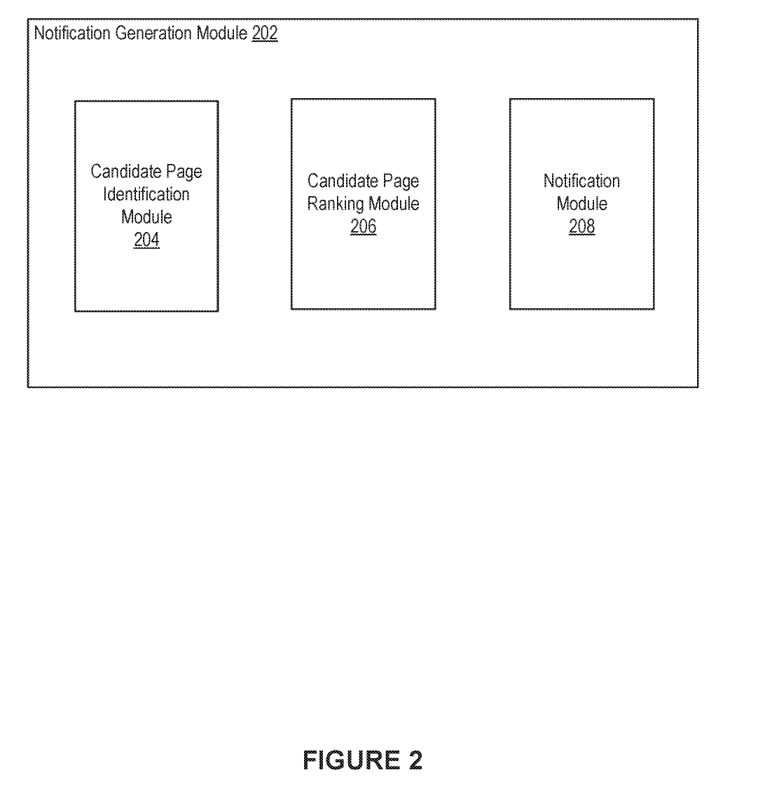

The notification generation module 106 can be configured to generate a location-based notification for a user. The notification generation module 106 can identify a set of new pages. For example, the set of new pages can comprise pages that have been created on a social networking system within a threshold period of time, e.g., within the previous 30 days. The notification generation module 106 can select a subset of the set of new pages to generate a set of candidate pages based on candidate page criteria. For example, the candidate page criteria can include location-based criteria, such that pages that are not associated with a user location associated with a user are filtered out and removed from consideration. Candidate page criteria can include additional criteria for filtering the set of new pages and/or selecting candidate pages, as will be described in greater detail herein. The notification generation module 106 can rank the set of candidate pages based on ranking criteria. In various embodiments, the ranking criteria can be implemented based on a machine learning model. For example, the machine learning model can be trained to rank pages based on a likelihood of a user to interact with a page if the page is presented to the user. The notification generation module 106 can identify one or more pages based on the ranking. The notification generation module 106 can generate a location-based notification which references the one or more pages and provide the location-based notification to a user. The notification generation module 106 is described in greater detail herein with reference to FIG. 2.

FIG. 2 illustrates an example notification generation module 202 configured to generate a location-based notification for a user, according to an embodiment of the present disclosure. In some embodiments, the notification generation module 106 of FIG. 1 can be implemented as the notification generation module 202. As shown in the example of FIG. 2, the notification generation module 202 can include a candidate page identification module 204, a candidate page ranking module 206, and a notification module 208.

The candidate page identification module 204 can be configured to identify a set of candidate pages based on candidate page criteria. The candidate page identification module 204 can identify a set of new pages. For example, the set of new pages can comprise pages that have been created on a social networking system within a threshold period of time, e.g., within the previous 30 days. The candidate page identification module 204 can select a subset of the set of new pages to generate a set of candidate pages based on candidate page criteria.

In one example, the candidate page criteria can comprise location criteria. In various embodiments, each page on a social networking system can be associated with a location, i.e., a page location. In one embodiment, a page's page location can be determined based on a location identified by an admin of the page, for example, during creation of the page. In another embodiment, a page's page location can be predicted. For example, a page's page location can be predicted based on a location associated with one or more admins of the page, e.g., if an admin of the page is associated with a particular location, the page can also be associated with the particular location. In another example, a page's page location can be predicted based on user locations for one or more followers of the page. For example, if a majority of a page's followers, or a greatest number of the page's followers, or a threshold number of the page's followers are associated with a particular location, it can be assumed that the page is also associated with the particular location. As discussed above, location-based notifications can be generated for a user based on a user location associated with the user. As such, for a particular user, location criteria can be used to filter out any pages that do not have a page location that matches the particular user's user location.

In another example, the candidate page criteria can comprise similarity score criteria. One example of similarity score criteria can include embedding similarity score criteria. In certain embodiments, pages can be assigned similarity scores with respect to a particular user based on vector representations (or embeddings) of the pages and the user. For example, a vector representation of a page, i.e., a page embedding, can be generated within an n-dimensional latent space based on page content. Page content can include, for example, a page's title, description, category, profile image, and the like. A user embedding for a user can also be generated and mapped to the same n-dimensional latent space based on pages that the user has interacted with. For example, a user embedding for a user can be generated based on all pages that the user follows. Page embeddings can be generated for all pages that the user follows. A user embedding for the user can be generated based on a combination of these page embeddings, e.g., an average pooling of the page embeddings. By mapping a page embedding associated with a page and a user embedding associated with a user to the same n-dimensional latent space, a similarity score can be calculated for the page and the user For example, the similarity score can be based on a cosine similarity for the page embedding and the user embedding. The candidate page identification module 204 can calculate similarity scores for each page in the set of new pages with respect to a particular user. Pages satisfying similarity score criteria can be selected for inclusion in the set of candidate pages. For example, pages satisfying a similarity score ranking threshold (e.g., the top 50 pages by similarity score) can be included in the set of candidate pages. In another example, pages satisfying a similarity score threshold (e.g., pages having a similarity score above a threshold) can be selected for inclusion in the set of candidate pages.

In certain embodiments, the candidate page criteria can include page interaction criteria. For example, pages that are trending within a particular location (e.g., a user location associated with a user) can be selected for inclusion in the set of candidate pages. In some embodiments, pages that are trending can be identified based on a page fanning rate. For example, a page's fanning rate can be calculated as the total number of fans divided by page age (e.g., in days). Using this formulation, a page that has been active for 5 days and has 500 followers would have a fanning rate of 100 followers/day, while a page that has been active for 10 days and has 100 followers would have a fanning rate of 10 followers/day. Pages can be ranked based on fanning rate. Pages that satisfy a fanning rate ranking threshold (e.g., the top 50 pages by fanning rate) and/or a fanning rate threshold (e.g., pages having a fanning rate above a threshold) can be selected for inclusion in the set of candidate pages.

The candidate page ranking module 206 can be configured to rank a set of pages, such as the set of candidate pages, based on ranking criteria. In certain embodiments, the ranking criteria can be implemented based on one or more machine learning models. For example, a machine learning model can generate a probability that a particular user will interact with a page if the page is presented to the user, as well as rank pages based on their respective probabilities. The machine learning model can be trained using a set of training data. The training data can include positive examples in which users were presented with pages and interacted with the pages (e.g., followed or subscribed to the page) and also negative examples in which users were presented with pages and did not interact with the pages. Based on the training data, the machine learning model can be trained to determine whether or not a particular user will interact with a particular page when presented with the page. The machine learning model can be trained based on a set of features. One example of a feature is whether a particular user has previously fanned pages in a particular category. For example, if a user has previously fanned several pages associated with local restaurants, but has never fanned a page associated with a local flower shop, then it can be more likely that the user will interact with a page for a new local restaurant than that the user will interact with a page for a new local flower shop. Another example of a feature is embedding similarity scores. As described above, vector representations (or embeddings) of users and pages can be mapped to a common latent embedding space, and similarity scores can be calculated between users and pages based on their vector representations (e.g., a cosine similarity). Embedding similarity scores can be used by the machine learning model as a feature in ranking pages for a particular user. Other examples of features in the set of features can include a user's gender, a user's age, the number of pages fanned by a user, a user's location, and the like. The set of features can also include page related features, such as a page category, a page age, a page location, etc.

The notification module 208 can be configured to generate and provide location-based notifications to a user. As discussed above, a set of candidate pages can be ranked by the candidate page ranking module 206. The notification module 208 can select one or more candidate pages based on the ranking. For example, the top n candidate pages can be selected based on the ranking. The notification module 208 can generate a location-based notification that references the selected candidate pages, and can provide the location-based notification to a user. For example, the user can be provided with a visual indication in a user interface indicating that the user has a new notification. When the user accesses the notification, the notification can notify the user of new pages that have been created that are associated with the user's user location. For example, an exemplary location-based notification can state: “Coffee Shop A and Restaurant B are new in your area! Be the first to visit their pages!” The location-based notification can include a link for the user to access the one or more candidate pages included in the location-based notification. In certain embodiments, the location-based notification can include a link to a subscription landing page which can direct the user to additional new pages associated with the user's user location.

In certain embodiments, a location-based notification can include not only notifications of new pages in a user's area, but also new offers or new events in the user's area. For example, if an entity associated with a page is offering a new offer or is hosting a new event in the user's area, the location-based notification can notify the user of the new offer or new event.

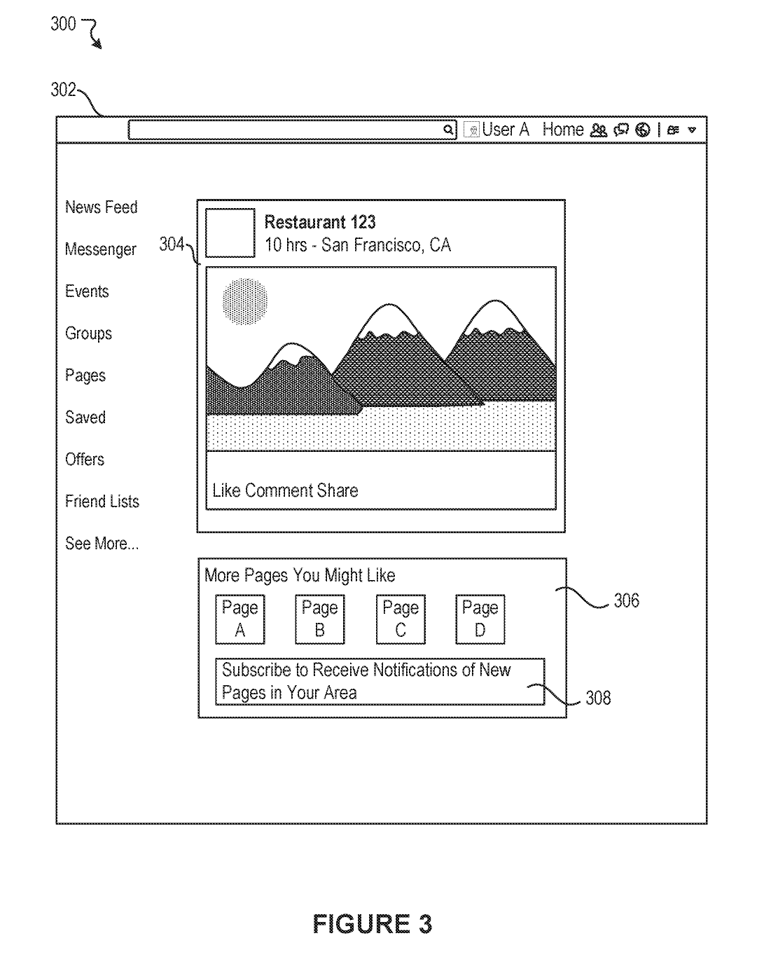

FIG. 3 illustrates an example scenario 300 associated with receiving a user request to subscribe to location-based notifications, according to an embodiment of the present disclosure. The example scenario 300 includes a user interface 302 presenting a news feed. The news feed includes a content post 304 posted by a page for an entity, Restaurant 123. A user viewing the user interface 302 has interacted with the content post 304 (e.g., by liking the content post 304, commenting on the content post 304, and/or sharing the content post 304). As a result of the user's interaction, the user is presented with a suggestion box 306. The suggestion box 306 includes additional pages that the user may be interested in (i.e., Page A, Page B, Page C, and Page D). The suggestion box 306 also includes a selectable interface object 308 that the user can select to subscribe to location-based notifications.

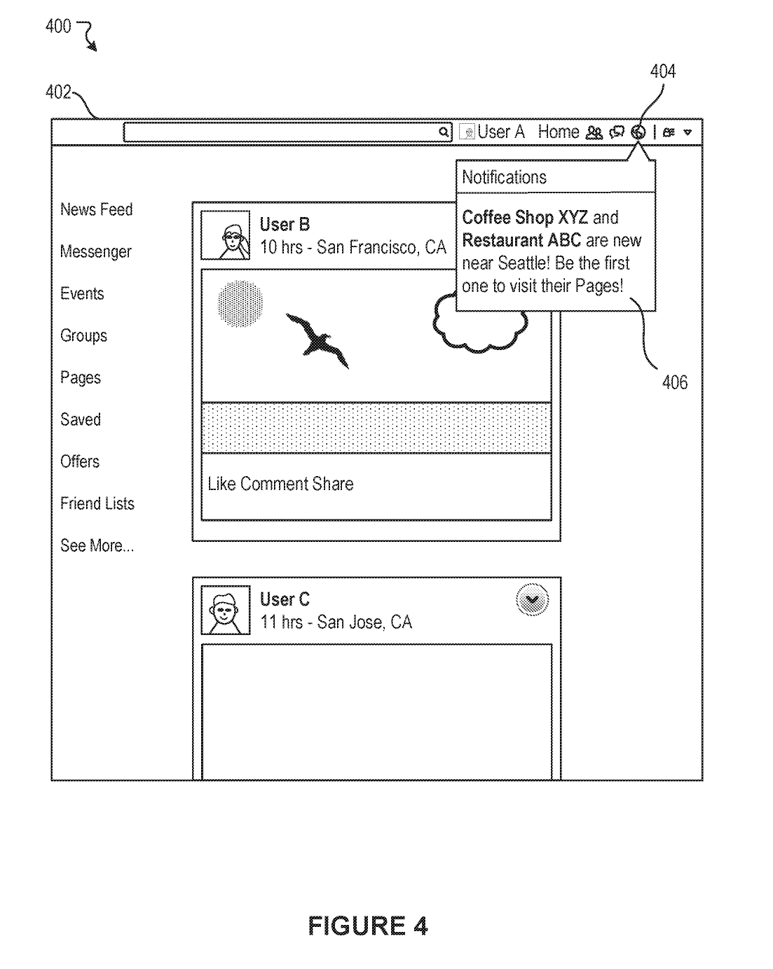

FIG. 4 illustrates an example scenario 400 associated with providing a location-based notification, according to an embodiment of the present disclosure. The example scenario 400 includes a user interface 402 presenting a news feed for a user, User A. In the example scenario 400, User A is associated with the location Seattle, Wash., and has subscribed to receive location-based notifications for Seattle, in accordance with functionality provided by the location-based notifications module 102. The user interface 402 includes a notification icon 404. User A has selected the notification icon 404 to display a dropdown notification display 406 comprising one or more notifications. The notification display 406 includes a location-based notification, which states: “Coffee Shop XYZ and Restaurant ABC are new near Seattle! Be the first one to visit their Pages!” In the example shown, Coffee Shop XYZ and Restaurant ABC have been determined in accordance with functionality provided by the location-based notifications module 102. In certain embodiments, the user can click on the words “Coffee Shop XYZ” to be directed to a page for Coffee Shop XYZ, or on the words “Restaurant ABC” to be directed to a page for Restaurant ABC.

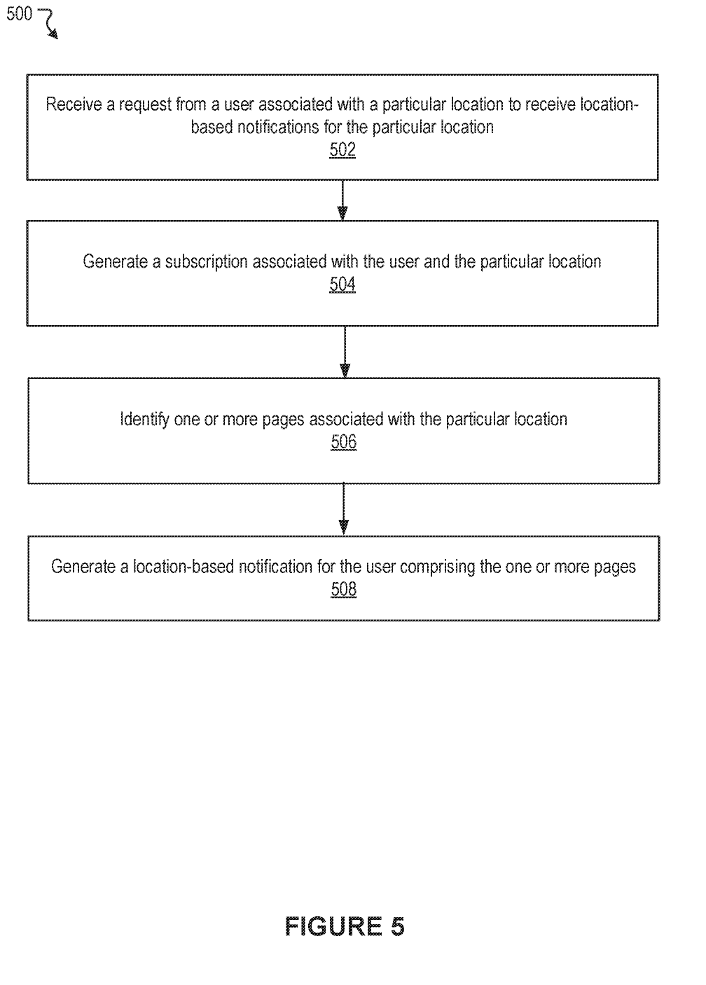

FIG. 5 illustrates an example method 500 associated with generating location-based notifications, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a request from a user associated with a particular location to receive location-based notifications for the particular location. At block 504, the example method 500 can generate a subscription associated with the user and the particular location. At block 506, the example method 500 can identify one or more pages associated with the particular location. At block 508, the example method 500 can generate a location-based notification for the user comprising the one or more pages.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a location-based notifications module 646. The location-based notifications module 646 can, for example, be implemented as the location-based notifications module 102, as discussed in more detail herein. As discussed previously, it should be appreciated that there can be many variations or other possibilities. For example, in some embodiments, one or more functionalities of the location-based notifications module 646 can be implemented in the user device 610.

### Hardware Implementation

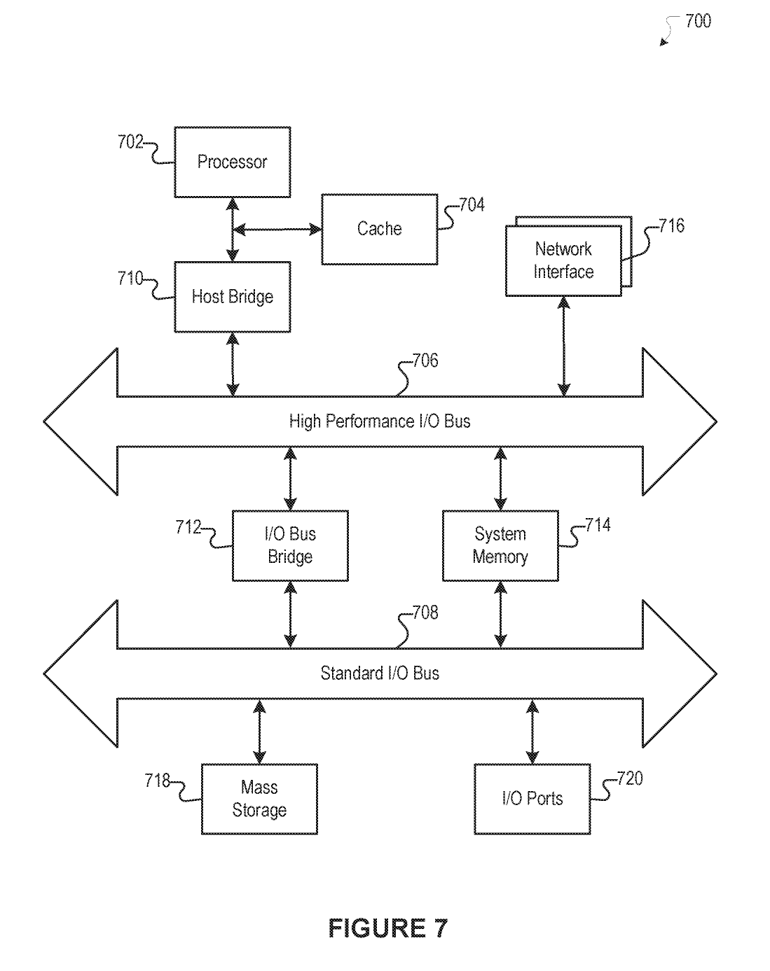

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a request from a user associated with a particular location to receive location-based notifications for the particular location;
generating, by the computing system, a subscription associated with the user and the particular location;
identifying, by the computing system, one or more pages associated with the particular location; and
generating, by the computing system, a location-based notification for the user comprising the one or more pages.

2. The computer-implemented method of claim 1, further comprising identifying a set of new pages, wherein
each new page in the set of new pages is a page that has been created within a threshold period of time, and
the identifying one or more pages comprises selecting the one or more pages from the set of new pages.

3. The computer-implemented method of claim 2, further comprising selecting a subset of the set of new pages to generate a set of candidate pages based on candidate page criteria, wherein the one or more pages are selected from the set of candidate pages.

4. The computer-implemented method of claim 3, further comprising ranking the set of candidate pages based on ranking criteria, wherein the one or more pages are selected from the set of candidate pages based on the ranking.

5. The computer-implemented method of claim 4, wherein the ranking criteria are implemented based on a machine learning model.

6. The computer-implemented method of claim 3, wherein the candidate page criteria comprise embedding similarity score criteria.

7. The computer-implemented method of claim 3, wherein the candidate page criteria comprise page interaction criteria.

8. The computer-implemented method of claim 1, further comprising periodically generating location-based notifications for the user based on the subscription, wherein each location-based notification comprises one or more pages associated with the particular location.

9. The computer-implemented method of claim 1, further comprising periodically generating location-based notifications for the user based on the subscription, wherein each location-based notification comprises one or more new pages that have been created within a threshold period of time and are associated with the particular location.

10. The computer-implemented method of claim 1, wherein
the subscription is associated with a particular page category, and
the identifying the one or more pages associated with the particular location comprises identifying one or more pages associated with the particular location and the particular page category.

11. A system comprising:
at least one processor; and
a memory storing instructions that, when executed by the at least one processor, cause the system to perform a method comprising:
receiving a request from a user associated with a particular location to receive location-based notifications for the particular location;
generating a subscription associated with the user and the particular location;
identifying one or more pages associated with the particular location; and
generating a location-based notification for the user comprising the one or more pages.

12. The system of claim 11, wherein the method further comprises identifying a set of new pages, and further wherein
each new page in the set of new pages is a page that has been created within a threshold period of time, and
the identifying one or more pages comprises selecting the one or more pages from the set of new pages.

13. The system of claim 12, wherein the method further comprises selecting a subset of the set of new pages to generate a set of candidate pages based on candidate page criteria, and further wherein the one or more pages are selected from the set of candidate pages.

14. The system of claim 13, wherein the method further comprises ranking the set of candidate pages based on ranking criteria, and further wherein the one or more pages are selected from the set of candidate pages based on the ranking.

15. The system of claim 14, wherein the ranking criteria are implemented based on a machine learning model.

16. A non-transitory computer-readable storage medium including instructions that, when executed by at least one processor of a computing system, cause the computing system to perform a method comprising:
receiving a request from a user associated with a particular location to receive location-based notifications for the particular location;
generating a subscription associated with the user and the particular location;
identifying one or more pages associated with the particular location; and
generating a location-based notification for the user comprising the one or more pages.

17. The non-transitory computer-readable storage medium of claim 16, wherein the method further comprises identifying a set of new pages, and further wherein
each new page in the set of new pages is a page that has been created within a threshold period of time, and
the identifying one or more pages comprises selecting the one or more pages from the set of new pages.

18. The non-transitory computer-readable storage medium of claim 17, wherein the method further comprises selecting a subset of the set of new pages to generate a set of candidate pages based on candidate page criteria, and further wherein the one or more pages are selected from the set of candidate pages.

19. The non-transitory computer-readable storage medium of claim 18, wherein the method further comprises ranking the set of candidate pages based on ranking criteria, and further wherein the one or more pages are selected from the set of candidate pages based on the ranking.

20. The non-transitory computer-readable storage medium of claim 19, wherein the ranking criteria are implemented based on a machine learning model.
